(19) United States
(12) Patent Application Publication
(10) Pub. No.: US 2003/0230369 A1
(43) Pub. Date: Dec. 18, 2003

(54) Use of spray-able anti-tack coating for puncture sealant tire application

(75) Inventors: Christine L. Domer, North Canton, OH (US); Jeffrey A. Bader, Akron, OH (US)

Correspondence Address: Chief Intellectual Property Counsel, Bridgestone/Firestone Americas Holding, Inc., 1200 Firestone Parkway, Akron, OH, 44317-0001, US

(73) Assignee: Bridgestone/Firestone North American Tire, LLC

(21) Appl. No.: 10/174,469

(22) Filed: Jun. 18, 2002

(51) Int. Cl. B05D 3/02; B60C 19/12

(52) U.S. Cl. 152/504; 427/385.5; 156/115; 53/431

(57) ABSTRACT

The present invention is directed to a method and apparatus to protect self-sealing tires from being damaged during shipment. The method for shipping self-sealing tires comprises the steps of applying a coating to the puncture sealant material on the tire and allowing the coating to cure. The method further includes arranging the tires including the cured coating in a shipment container in a predetermined configuration, followed by shipment of the tires.

### BACKGROUND OF THE INVENTION

The present invention relates to the shipment of tires. More particularly, the present invention relates to the application of an anti-tack coating to a tire in order to prevent damage to the tire during shipment. The present invention finds particular application with respect to tires that include a tire puncture sealant material layer.

Tires are typically shipped to retail establishments via truck and/or railroad car. However, the sheer weight of the tires stacked on one another in a railroad car, crate or truck for shipment crushes tires at the bottom of the pile.

Damage resulting from tires being crushed is often increased when the tire includes a puncture sealant material layer. The purpose of the puncture sealant material is to seal a puncture of the tire as quickly as possible, without the need to immediately service the tire. The increased risk of damage from the tire being crushed arises from the high tack nature of the puncture sealant material layer, i.e., the stickiness of the coating.

Moreover, once a tire has too much weight on top of it, the tire sides buckle, potentially damaging the puncture sealant material layer. Similarly, if the sealant layer contacts other portions of the tire and folds over itself, the significant stickiness of the puncture sealant layer can cause the buckled tire to retain a distorted shape. Therefore, it is desirable to protect the layer of puncture sealant material from being ruined, or distorting the tire shape, during shipment of the tire.

The tire puncture sealant material is applied to the interior of a pneumatic tire along the tread area for the purpose of self-sealing the puncture and preventing rapid air loss. The puncture sealant material usually has sufficiently high adhesive tack to metal (usually nails) to effectuate a proper seal between the puncturing object and the tire. Due to the high tack nature, i.e., stickiness, of the puncture sealant, precautions need to be taken in shipping truckload or railcar quantities of sealant tires to prevent the tires from crushing in on themselves during shipping. If crushed during shipping, the tires may become permanently distorted due to the sealant and lose stability, thus rendering collapsed tires incapable of use.

Traditional shipping methods include: shipped loose lace with a trailer cushion, shipping the tires bundled in small units (e.g., 2 or 4), either banded, or shrink or tension wrapped, shipped loose laced with a reduced stack height, shipped stove-piped with a reduced stack height, shipped stove-piped on skids, boxing the tires individually, using cardboard bead spacers and circumferentially banded tires to force the beads apart in shipping. However, due to the presence of the puncture sealant material layer, it is typically necessary to use less efficient shipping methods in order to overcome damage from crushing.

Alternatively, high cost release paper liners are used to prevent shipment damage. However, release paper liners require inefficient manual application, as well as manual removal of the release paper liner once the tires reach their destination. Accordingly, a need exists for more efficient shipment of tires having a puncture sealant material layer.

### SUMMARY OF THE INVENTION

The present invention is directed to the use of a coating to eliminate surface tack of tires including a puncture sealant material layer for protection against normal shipment damage in those tires, without hindering the performance of the puncture sealant material.

In one embodiment of the present invention, a method is provided for shipping tires including a puncture sealant material layer. The method includes applying a coating to the puncture sealant material layer, and allowing the coating to cure. The method further includes arranging the tires including the coating in a shipment container and shipping the tires.

In another embodiment of the present invention, a self-sealing tire is provided comprising a treadwall and a sidewall, where the treadwall includes an exterior face for engaging the ground and an opposed interior face that includes a puncture sealant material layer. The self-sealing tire further includes a substantially anti-tack coating material layer that substantially covers the puncture sealant material layer.

In yet another embodiment of the present invention, a process is provided for shipping tires including a puncture sealant material layer. The process includes spraying a coating layer having a thickness of at least 0.005 inches over the puncture sealant material layer and curing the coating layer in order to achieve an anti-tack condition. The process further includes placing the coated tires in a generally predetermined configuration within a shipment container.

It is one advantage of the present invention to maintain the puncture sealant material layer performance, while protecting the sealant layer in the event the tire is crushed during shipping.

Other advantages and embodiments of the present invention will become apparent to one having ordinary skill in the art upon a reading and understanding of the detailed description of the preferred embodiment.

### DESCRIPTION OF THE DRAWINGS

The present invention may take form in various components and arrangements of components, and/or in various steps and arrangements of steps. The drawings are only for purposes of illustrating preferred embodiments and are not be construed as limiting the invention.

FIG. 1 shows the cross-section of a typical tire having a puncture sealant material layer.

FIG. 2 shows a cross-section of a typical tire having a puncture sealant material layer that has collapsed during shipping.

FIG. 3 shows a cross-section of a tire having a puncture sealant material layer and a spray-able anti-tack coating layer.

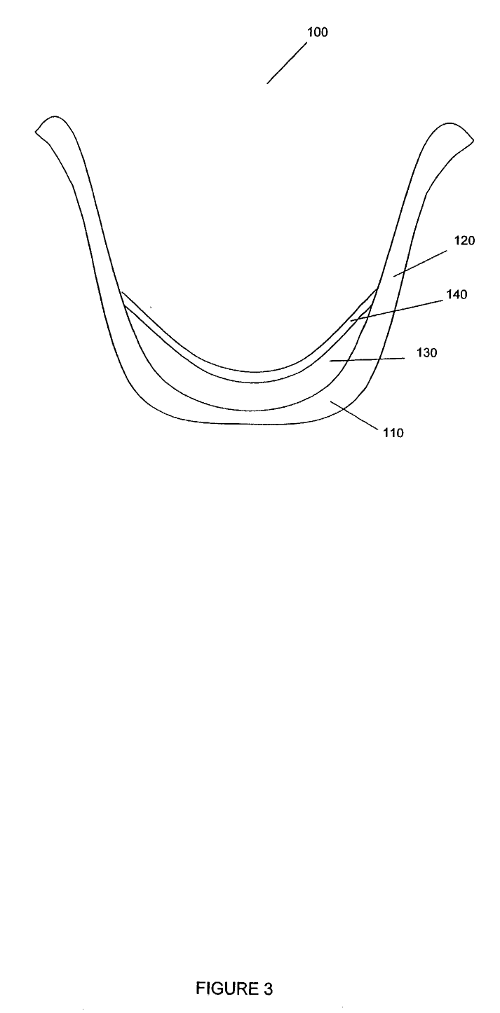

### DETAILED DESCRIPTION OF THE PREFERRED EMBODIMENTS

The present invention relates to the application of a spray-able anti-tack coating onto the interior surface of a tire having a puncture sealant material layer in order to prevent the sealant layer of the tire from being damaged or inadvertently sticking during shipment.

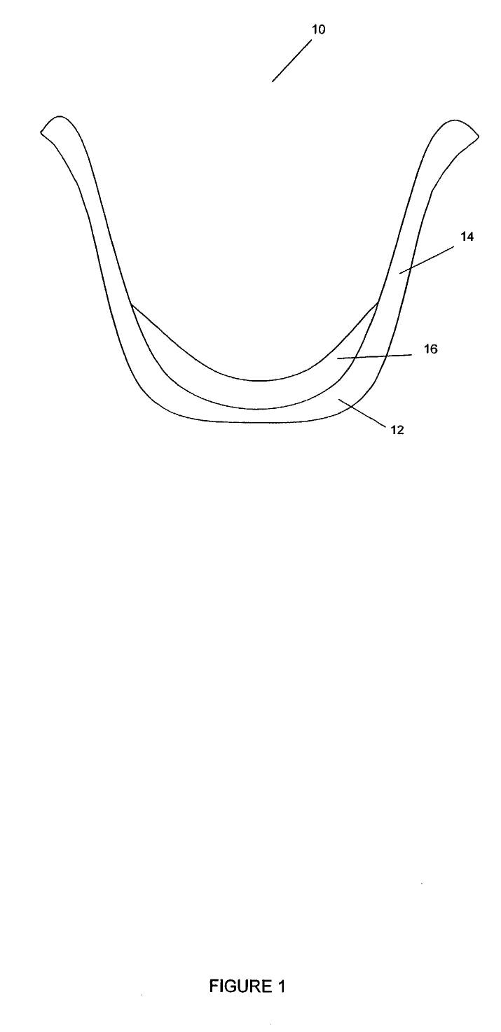

With reference to FIG. 1, a traditional tire 10 having a puncture sealant material layer is shown. The tire includes a treadwall 12 which engages the surface of the road, and sidewalls 14 which support the tire vertically. In addition, the tire includes a puncture sealant material layer 16 which functions to seal the tire in the event of a puncture.

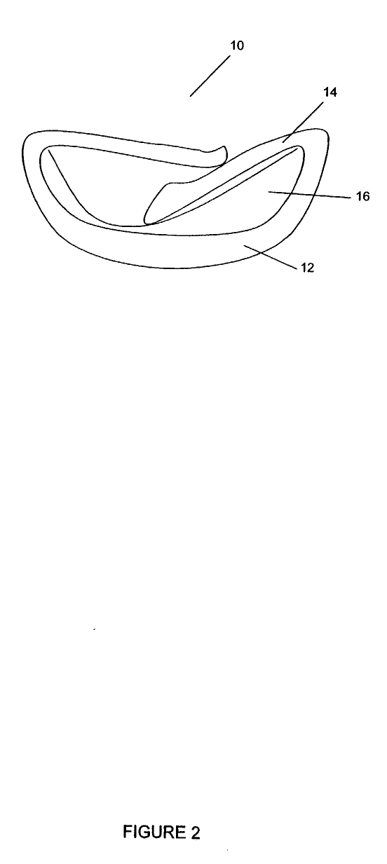

Due to the high tack nature of the puncture sealant material layer, caution must be taken with respect to the handling of the tires once ready for shipment. If excessive loads of weight are applied, the sidewalls 14 of the tire can collapse and become engaged with the puncture sealant material layer 16, as shown in FIG. 2. Alternately, it is possible that the sidewalls do not become permanently engaged, but rather, become temporarily engaged and upon separation and, the tack coating is disturbed, thus diminishing performance of the puncture sealant material layer.

The present inventive method/device for preventing self-sticking of the sealant layer during is suited for use with any known tire sealant material, and is most beneficial when used with high tack materials. One exemplary puncture sealant composition is disclosed in U.S. Pat. No. 4,116,895 issued to Kageyama et al., the subject matter of which is incorporated herein by reference. In Kageyama, the puncture sealant composition in emulsion for a tubeless pneumatic tire preferably comprises a butyl rubber emulsion, at least one additional rubber component selected from the group consisting of diene type unsaturated hydrocarbon polymer emulsions and a natural rubber latex, at least one saturated hydrocarbon polymer emulsion, a crosslinking agent for the rubbers and a crosslinking activator.

In addition, the puncture sealant composition can be self-curing, as disclosed in U.S. Pat. No. 4,616,048 to De Trano et al., the subject matter of which is incorporated herein by reference. Accelerated cure systems for puncture sealant compositions for use in the present invention preferably utilize peroxide and quinoid curing agents which are solid or impregnated on solid fillers in conjunction with select polar solvent accelerators. In De Trano, the quinoid vulcanizing accelerator is mixed with a rubber masterbatch prior to sequential or concurrent addition of the peroxide curing agent and the select polar solvent accelerator. Alternatively, the peroxide curing agent, quinoid vulcanizing agent and the select polar solvent can be added in any order or conjointly.

Furthermore, the puncture sealant layer can be a uniform dispersion of small quinoid particles without the use of polar, organic solvents to solubilize the curing agent, as is taught by U.S. Pat. No. 6,303,694 B1 to Hogan et al., the subject matter of which is incorporated herein by reference. In Hogan, the sealant composition is prepared by mixing an elastomer in the substantial absence of an organic solvent and separately dispersing a quinoid curing agent in a polymer to form a curing agent concentrate. The curing agent concentrate is then combined with the elastomer to form the sealant composition.

Once a puncture sealant material layer has been applied to the interior surface of the tire, a coating according to the present invention is applied to eliminate surface tack of the tire puncture sealant for protection against normal shipment damage in self-sealing tires. Desirably, the coating does not interfere with or hinder the self-sealing performance of the puncture sealant material layer. Thus, the coating preferably has no effect on the self-sealing performance of the tire, unlike the use of release paper liner, which, if left on during usage, can have a significant negative effect on the sealing performance of the tire.

The coating on the puncture sealant material layer is preferably a spray-able material, thus offering low processing costs using commercially available, automated, ambient, simple spray equipment versus the labor intensive hand application and removal of paper liners. Furthermore, the use of a spray-able coating significantly reduces material, processing costs and shipping costs as compared to paper release liners due to less expensive materials, process automation and simplification and the use of normal shipping methods.

Preferably, the puncture sealant material layer has a greater thickness than that of the coating. The puncture sealant material layer will typically have a thickness from about 1.0 to about 10.0 mm, and be located on the inner surface of the tire. The coating layer will preferably have a thickness in the range of about 0.50 to about 2.0 mm, and be located adjacent to the puncture sealant material. Thus, the coating layer will substantially cover the puncture sealant material, rendering the puncture sealant material layer entrapped between the tire and coating layer. It is important, however, that the coating layer not be so thick as to interfere with the self-sealing capabilities of the puncture sealant layer material.

The coating compositions typically contain four basic components. One component for the coating composition is a polymeric resin. Also included are solvents which prevent the resins from liquefying until the coating is applied. Pigments are also included to add color and also promote adhesion. Finally, additives are included for drying, thickening, or as anti-foam agents. In addition, the coating can include other components, such as titanium dioxide, dibutyl phthalate and/or iron oxide.

Two types of polymeric resins commonly used in formulating suitable paints include: (i) an all acrylic system, e.g., copolymers of methyl methacrylate, butyl acrylate or 2-ethylhexyl acrylate with small amounts of functional monomers, such as carboxylic acids; and (ii) vinyl acetate-based copolymers usually in combination with a small proportion of lower alkyl acrylates, such as, for example, butyl acrylates. Because of its low cost, vinyl acetate is an attractive alternative to certain acrylate monomers, e.g., methyl methacrylate, for use in architectural coating latexes.

Ethylene is a desirable comonomer for polymerization with vinyl acetate to form coatings for the present invention because ethylene has properties which can compensate for the shortcomings of vinyl acetate, which include poor hydrolytic stability. More specifically, because of ethylene's low molecular weight, it permits a high level of introduction of non-hydrolyzable segments on a per weight basis which can improve the hydrolytic stability properties of the vinyl acetate copolymer. Thus, the hydrocarbon segments provided by the ethylene tend to reduce water solubility, thus imparting greater hydrolytic stability. Moreover, ethylene has a low glass transition temperature which can provide enhanced copolymer hydrophobicity and enhanced water and alkali resistance.

Alternatively, alkene latex copolymers may be employed in coating compositions in accordance with the present invention. The alkene latex copolymer compositions comprise an inner particulate material and an outer copolymer copolymerized from the alkene and the other monomer(s). Lower vinyl esters, e.g., vinyl acetate, are used as comonomers with the alkenes in order to provide the latex copolymer composition with desirable properties. In the production of alkene latex copolymers, the inner particulate material is introduced to a reaction zone either prior to do during the introduction of an alkene monomer, e.g., ethylene, and a lower vinyl ester monomer, e.g., vinyl acetate, and optionally other monomers, e.g., higher vinyl esters, such as, for example, vinyl neodecanoate. In another aspect of production, the process involves a polymerization of at least one vapor monomer, e.g., ethylene, and at least two liquid monomers, e.g., vinyl acetate and vinyl neodecanoate, wherein the two liquid monomers are introduced to the reaction zone at feed rates which are varied in a manner effective to enhance the incorporation of the vapor monomer into the latex copolymer.

Preferred coating compositions include any type of latex-based paint. Most preferably, coating compositions for the present invention include a poly-vinyl acetate (PVA) component.

The coating layer preferably includes a water soluble polymer, such as poly-vinyl acetate, to the resin emulsion, to promote adhesion to the substrate, prevent coagulation of the pigment paste formulation, prevent pigment settling, enhance pigment dispersion and adjust viscosity of the final printing ink. Suitable polymers include polyvinyl pyrrolidone, polyacrylamide, solubilized acrylic acid-vinyl acetate/vinyl alcohol inter polymers and the like. The selection of the water soluble polymer will be guided by the substrate with amounts varying from about 1 to about 20% by weight based on the weight of the emulsion with about 5 to about 15% preferred, e.g. 5%, 10%, 12% and 15%.

The pigments may be organic or inorganic and functionally contribute to opacity and color in addition to durability and hardness, although some paints contain little or no opacifying pigments and are described as clear coatings. Preferably, coatings for the present invention include a carbon black additive, which, in addition to adding to the durability and adhesion of the coating, serve an aesthetically pleasing purpose in matching the coating with the same color as the interior surface of the tire. The manufacture of coatings for use in the present invention involves the preparation of a polymeric binder, mixing of component materials, grinding of pigments in a dispersant medium, and thinning to a desired consistency, usually in accordance with commercial standards.

Compositions that are preferred for the present inventive coating compositions typically include about 1 to about 80 weight percent resin, preferably about 2 to 50 and most preferably about 3 to 40 weight percent of the total coating composition. The coating may also contain about 20 to about 90 weight percent water and from about 0.1 to about 10 weight percent of other additives including for example, thickeners, pigments, preservative, surfactants, dispersants and the like. Typical components include, but are not limited to, one or more of the following: solvents such as aliphatic or aromatic hydrocarbons, alcohols, esters, ketones, glycols, glycol ethers, nitroparaffins or the like; pigments; fillers, dryers, flatting agents; plasticizers; stabilizers; dispersants; surfactants; viscosifiers including other polymeric additives, cellulose ether based thickeners and so on; suspension agents; flow control agents; defoamers; anti-skinning agents; preservatives; extenders; filming aids; other crosslinkers; surface improvers; corrosion inhibitors; and other ingredients that may be useful in paint coating compositions.

One exemplary latex paint compositions suited for use in the present invention is available from Sherwin Williams in Cleveland, Ohio as (trade name)?. The paint comprises: 5 wt % 2-(2-Methoxyethoxy)-ethanol, 3 wt % 2-(2Butoxyethoxy)-ethanol, 2 wt % oxo-tridecyl acetate, 5 wt % ethylene glycol, 26 wt % titantium dioxide, 1 wt % carbon black and less than 3 wt % of kaolin and less 3 wt % t21c that is due to tinting. The remaining portion of the composition consists essentially of water. Other formulations that are suitable in the present invention include Darmex PR-41 and Darmex OP-20 PF (available from ______ ).

Other types of commercial coatings that are suited for the present invention include ______.

The invention has been described with reference to the preferred embodiments. Obviously, modifications and alterations will occur to others upon a reading and understanding of this specification. It is intended that the invention be construed as including all such modifications and alterations insofar as they come within the scope of the appended claims or the equivalents thereof.

Having thus disclosed the invention with particularity, the invention is claimed to be:

1. A method for shipping tires including a puncture sealant material layer comprising:
applying a coating to said puncture sealant material layer;
curing said coating;
arranging said tires including the said coating in a shipment container; and
shipping said tires.

2. The method of claim 1 wherein said coating comprises a water-based paint.

3. The method of claim 2 wherein said paint includes a poly-vinyl alcohol.

4. The method of claim 3 wherein said paint includes a carbon black.

5. The method of claim 1 wherein said cure is completed.

6. The method of claim 1 wherein said tires are arranged in a herringbone pattern.

7. The method of claim 1 wherein said puncture sealant material layer is thicker than said coating.

8. The method of claim 1 wherein said coating is applied by spraying.

9. A self-sealing tire comprising:
a treadwall and sidewall, said treadwall including an exterior surface for engaging the ground and an opposed interior surface, said interior surface including a puncture sealant material layer; and
a substantially anti-tack coating layer substantially covering the puncture sealant material layer.

10. The self-sealing tire of claim 9 wherein said coating layer comprises cured paint.

11. The self-sealing tire of claim 10 wherein said paint includes polyvinyl alcohol.

12. The self-sealing tire of claim 11 wherein said paint further includes carbon black.

13. The self-sealing tire of claim 9 wherein said puncture sealant layer is thicker than said coating layer.

14. A process for shipping tires includes a puncture sealant layer having a thickness of at least 0.005 inches and comprising:
spraying a coating layer over the puncture sealant layer;
curing said coating layer to achieve an anti-tack condition; and placing said coated tires in a predetermined configuration within a shipment container.

15. The process of claim 14 wherein said anti-tack coating layer is smaller in thickness then said tire puncture sealant layer.

16. The process of claim 14 wherein said anti-tack coating is applied using spray application.

17. The process of claim 14 wherein said anti-tack coating is at least 0.005 inches thick.

18. The process of claim 14 wherein said anti-tack coating layer includes a poly-vinyl alcohol.

19. The anti-tack coating layer of claim 18 further includes a carbon black.

20. The process of claim 14 where said predetermined configuration is a herringbone configuration.
